(19) United States
(12) Patent Application Publication
(10) Pub. No.: US 2026/0259831 A1
(43) Pub. Date: Sep. 3, 2026

(54) HARDWARE PREFETCHING OF EXTENDED CACHE BLOCKS

(71) Applicant: ARTERIS, INC., Campbell, CA (US)

(72) Inventor: Pierre-Axel LAGADEC, Villa du Fond (FR)

(73) Assignee: ARTERIS, INC., Campbell, CA (US)

(21) Appl. No.: 19/067,986

(22) Filed: Mar. 2, 2025

(51) Int. Cl. G06F 12/0862

(52) U.S. Cl. CPC G06F 12/0862; G06F 2212/6028

(57) ABSTRACT

An electronic system includes a plurality of partitions, system memory, and a hardware prefetch engine for performing pre-fetches on all cache lines in an extended cache block other than a cache line at a missed address. Extended cache block size is partition-dependent.

### TECHNICAL FIELD

The present technology is in the field of electronic systems.

### BACKGROUND

An electronic system may include a processor that communicates with main memory. Consider the example of a central processing unit (CPU) that accesses data and instructions from main memory such as dynamic random access memory (DRAM). Latency to access the data and instructions from the DRAM is huge in comparison to frequency of the CPU. Without cache prefetching, the CPU might wait hundreds of clock cycles for the data and instructions.

Cache prefetching is a technique used by processors to improve system performance by prefetching instructions or data from their original storage in slower memory to faster local memory before being accessed. Data prefetching fetches data before that data is needed. Instruction prefetching fetches instructions before those instructions are executed. Accessing prefetched data or instructions from a cache is usually many orders of magnitude faster than accessing the data or instructions directly from main memory.

One type of prefetching is automatic hardware prefetching. An automatic hardware prefetching engine attempts to predict which cache line will be newly used, and prefetches it. Hardware prefetching is typically performed by a dedicated hardware device that observes the stream of instructions or data being requested by a processor, recognizes the next few elements that the processor might need based on this stream, and prefetches those elements into a cache.

### SUMMARY

In accordance with various embodiments and aspects herein, an electronic system includes a plurality of partitions, system memory, and a hardware prefetch engine for performing pre-fetches on all cache lines in an extended cache block other than a cache line at a missed address. Extended cache block size is partition-dependent.

An electronic system includes a plurality of partitions and system memory. In accordance with various embodiments and aspects herein, a module for the electronic system includes cache, and a prefetch engine configured to respond to a cache miss by generating a number of prefetch requests for all cache lines in an extended cache block other than a cache line at a missed address. The number of prefetch requests is determined at runtime on a per-partition basis.

An electronic system includes a cache and shared memory. In accordance with various embodiments and aspects herein, a method implemented by the electronic system includes using a memory access request to search the cache for a cache line. If a cache miss occurs, a missed cache line is copied from the shared memory into the cache. Further, a first field of the memory access request is used to identify an extended cache block associated with the missed cache line; and a second field of the memory access request is used to identify all cache lines in the extended cache block other than the missed cache line. Prefetch requests are generated for all of the cache lines in the extended cache block other than the missed cache line.

### BRIEF DESCRIPTION OF THE DRAWINGS

In order to understand the invention more fully, reference is made to the accompanying drawings. The invention is described in accordance with the aspects and embodiments in the following description with reference to the drawings or figures (FIG.), in which like numbers represent the same or similar elements. Understanding that these drawings are not to be considered limitations in the scope of the invention, the presently described aspects and embodiments and the presently understood best mode of the invention are described with additional detail through use of the accompanying drawings.

FIG. 1 shows an electronic system including a plurality of partitions, system memory, cache, and a hardware prefetch engine in accordance with various aspects and embodiments herein.

FIG. 2 shows an address of a memory access request in accordance with various aspects and embodiments herein.

FIG. 3 shows processing of first and second memory access requests in accordance with various aspects and embodiments herein.

FIG. 4 shows a method implemented in accordance with various aspects and embodiments herein.

FIG. 5 shows cache and a prefetch engine in accordance with various aspects and embodiments herein.

FIG. 6 shows a system-in-chip including a prefetch engine in accordance with various aspects and embodiments herein.

### DETAILED DESCRIPTION

The following describes various examples of the present technology that illustrate various aspects and embodiments of the invention. Generally, examples can use the described aspects in any combination. All statements herein reciting principles, aspects, and embodiments as well as specific examples thereof, are intended to encompass both structural and functional equivalents thereof. The examples provided are intended as non-limiting examples. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment of the invention.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments of the invention described herein are merely exemplary, and should not be construed as limiting of the scope or spirit of the invention as appreciated by those of ordinary skill in the art. The disclosed invention is effectively made or used in any embodiment that includes any novel aspect described herein. All statements herein reciting principles, aspects, and embodiments of the invention are intended to encompass both structural and functional equivalents thereof. It is intended that such equivalents include both currently known equivalents and equivalents developed in the future. Furthermore, to the extent that the terms “including”, “includes”, “having”, “has”, “with”, or variants thereof are used in either the detailed description and the claims, such terms are intended to be inclusive in a similar manner to the term “comprising.”

As used herein in the context of prefetching, the term “data” refers to data, or instructions, or both. Thus, the prefetching of data may include the prefetching of data only, instructions only, or the combination of data and instructions.

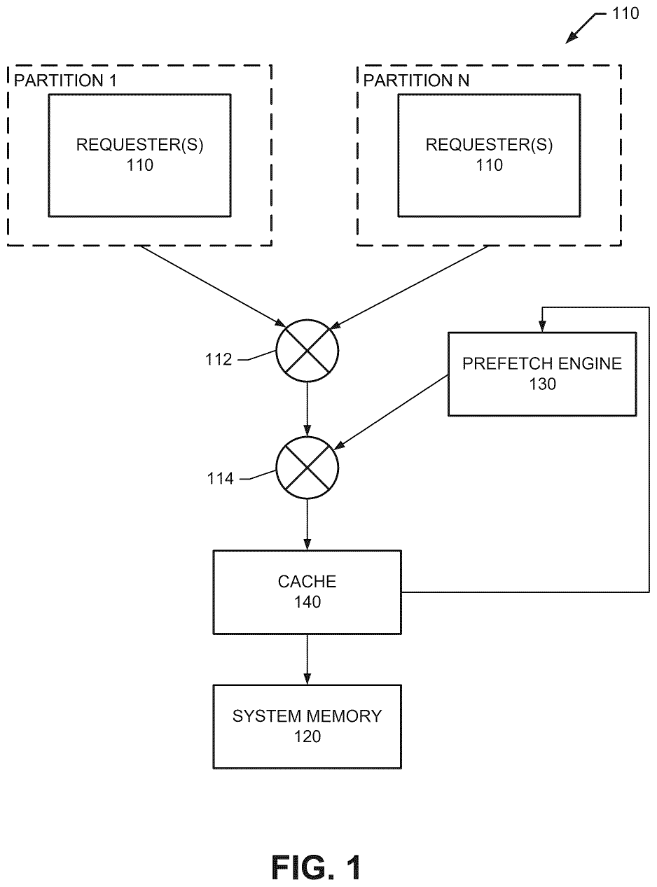

Reference is made to FIG. 1, which illustrates an electronic system 100 including a plurality of “requesters” 110, system memory 120, a hardware prefetch engine 130, and cache 140. As used herein, a requester 110 is configured to issue memory access requests such as read requests and write requests. Examples of a requester 110 include, but are not limited to, a CPU core, a graphics processing unit (GPU) core, a digital signal processor (DSP) core, and a machine learning (ML) accelerator.

The electronic system 100 of FIG. 1 includes partitions 1 to N. As used herein, a “partition” may represent a single requester 110, a group of requesters 110, a range of addresses, or specific information sent by one or more requesters 110. A requester 110 is not limited to association with a single corresponding partition. In some instances, a requester 110 may be associated with multiple partitions. The different partitions provide a way to differentiate between different traffic patterns and different policies.

Memory access requests from the different partitions are supplied to a multiplexer 112. The multiplexer 112 selectively forwards the requests to a switch 114.

The cache 140 may be dedicated to a single requester 110 (e.g., as level 2 cache of a CPU core), or shared among a cluster of requesters 110 (e.g., as level 3 cache of a CPU having a cluster of cores), it may be a last level cache that is shared among all requesters 110, or it may be at a memory interface. Accessing cache lines from the cache 140 is many orders of magnitude faster than accessing cache lines directly from the system memory 120.

Each address in the address space of the system memory 120 maps to a cache line. Size of each cache line is 2\hat{ }N bytes. The cache lines range in size from 32 bytes to 512 bytes, but are typically 64 bytes. Each cache line may include, but is not limited to, a valid bit, a tag, and data.

As used herein, an “extended cache block” refers to a block of cache lines. The number of cache lines in an extended cache block is 2\hat{ }L. The value for L may be set at runtime.

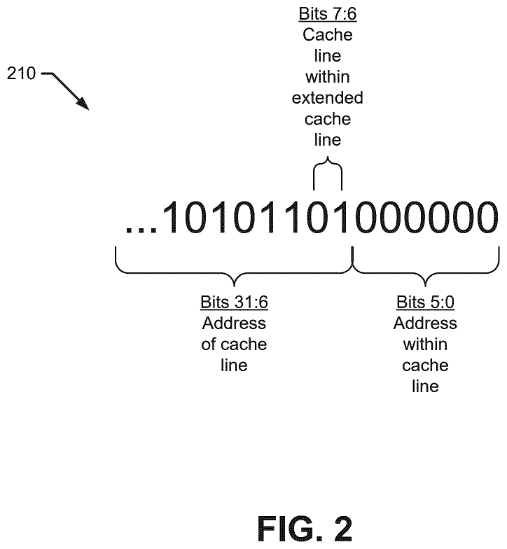

Additional reference is made to FIG. 2, which illustrates an example of a read request 210. In this example, the read request includes a 32-bit address (only the lower 14 bits are shown). For a cache line having 2\hat{ }6=64 bytes, bits 31:8 of the address identify an extended cache block within the cache 140. Bits 7:6 identify a cache line within the extended cache block. Bits 5:0 of the address identify a byte within that cache line. Thus, bits 31:6 identify a cache line in the cache 140. As many as 2\hat{ }26 addressable cache lines may be addressed, but fewer cache lines may be stored in the cache 140.

When the requester 110 issues a read request, the request is sent to the cache 140 (via the multiplexer 112 and the switch 114), and the cache 140 is searched. If valid bit==1 and bits 31 to 6 match the tag of a cache line, then there is a hit, and a copy of the data in that cache line is supplied to the requester 110. The cache line remains in the cache 140 for reuse.

If bits 31 to 6 do not match the tag of any cache lines in the cache 140, then there is a cache miss. The cache line at the missed address (hereinafter, the “missed cache line”) is read from the system memory 120 and stored in the cache 140. A copy of the data at the missed cache line is sent to the requester 110.

The missed cache line is associated with an extended cache block (in the example of FIG. 2, the extended cache block is identified by bits 7:6). There are other cache lines in that extended cache block. The prefetch engine 130 is configured to generate prefetch requests for the other cache lines. The prefetch requests are sent to the cache 140 (via the switch 114), the other cache lines are read from the system memory 120, and the prefetched cache lines are stored in the cache 140.

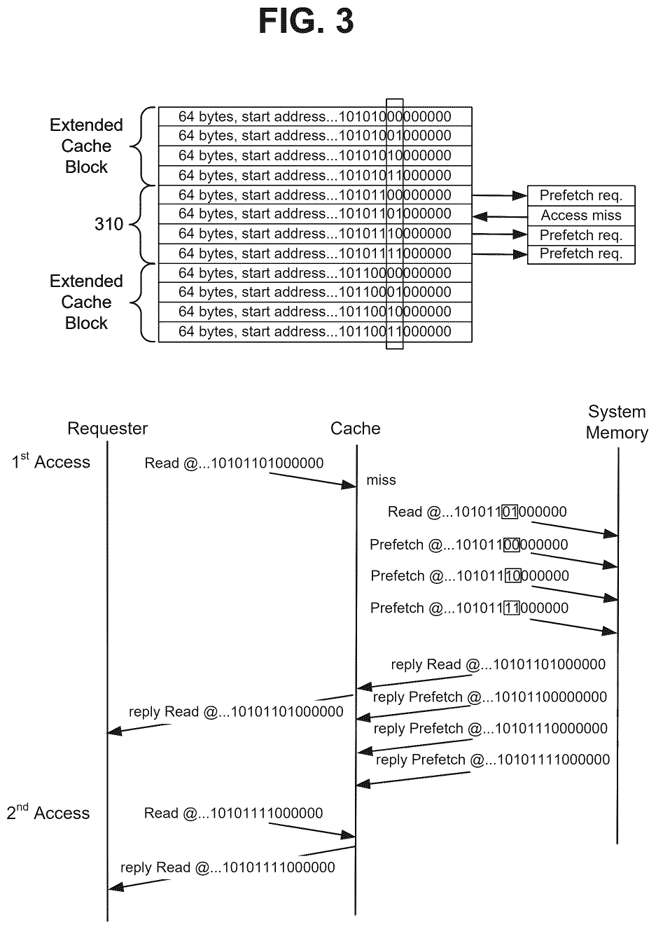

Reference is made to FIG. 3, which illustrates an example of an extended cache block 310 and two other extended cache blocks. Each extended cache block includes four cache lines of 64 bytes. Size of the extended cache block 310 is a power of two times the cache line size. In the example of FIG. 3, each extended cache block has a size of 256 bytes. The extended cache block 310 is aligned on its size, that is, the start address of the extended cache block modulo its size is zero. The start address of the extended cache block 310 is 10101100000000. The start addresses of the other two extended cache blocks are 10101000000000 and 10110000000000, respectively.

FIG. 3 further illustrates a first cache access. A read request is issued for an address of a cache line that is not in the cache 140. Therefore, a cache miss occurs. The cache line at the missed address is read from the system memory 120 and stored in the cache 140. A copy of the data at the missed cache line is sent to the requester 110.

The missed cache line is associated with the extended cache block 310, which has three other cache lines (as identified by bits 6:7). Prefetch requests are generated for the three other cache lines in the extended cache block. Those other cache lines are prefetched from the system memory 120 and stored in the cache 140 (where they may be read later).

FIG. 3 also illustrates a second cache access in which a read request is issued and a cache hit occurs. In response, data at the address of the cache hit is sent to the requester 110.

Thus, the missed cache line is read, and prefetch requests for the other cache lines in the extended cache block are generated. Advantageously, average data access latency is reduced.

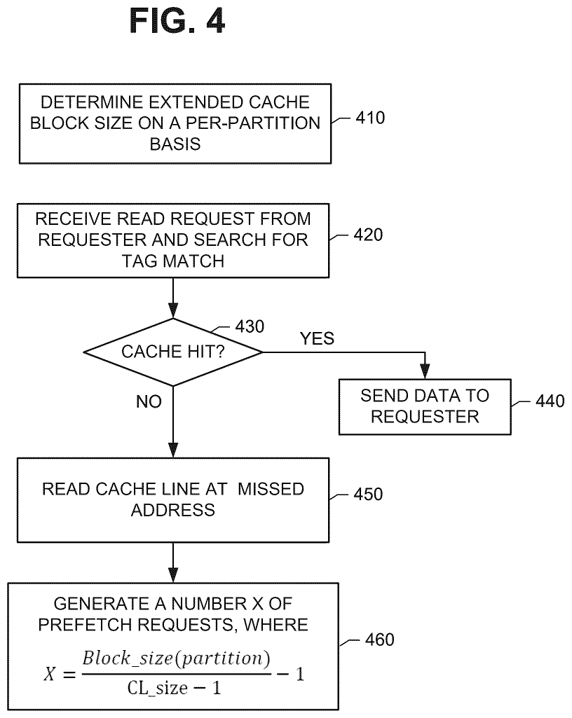

Reference is now made to FIG. 4, which illustrates a method in which extended cache block size is partition-dependent. At block 410, extended cache block size is determined on a per-partition basis. The size may be determined, for example from characteristics of data sets handled by requesters 110 in a partition. For instance, extended cache block size may be a function of traffic patterns and policies. If a requester 110 usually works on large data sets at consecutive addresses, a large extended cache block will be beneficial. If a requester 110 usually works on small data sets and/or data sets at non-consecutive addresses, a small extended cache block will be beneficial.

In some embodiments, a trained machine learning (ML) model is used to determine the extended cache block size for each partition. An ML model using a classification algorithm or a regression algorithm may be trained on a training dataset that has working dataset sizes for different partitions. Feedback may be received on hits and misses for different sizes, and that feedback may be used to retrain the ML model.

Block 420 is entered during runtime, when a read request is received from a requester 110. The cache 140 is searched. If valid bit==1 and bits 31 to 6 of the read address match the tag of a cache line, then there is a hit (block 430), and a copy of the data in that cache line is supplied to the requester 110 (block 440).

If there is a cache miss (block 430), the cache line at the missed address is read from system memory 120 and stored in the cache 140 (block 450). Its data is supplied to the requester 110.

At block 460, the cache line at the missed address is associated with an extended cache block having a block size of Y-Block_size(partition) bytes-aligned. A number X of prefetch requests are generated for all other cache lines in the extended cache block, where

$$X = \frac{Block\_size ( partition )}{CL\_size - 1} - 1.$$

The prefetched cache lines are stored in the cache 140. For example, if there are eight cache lines in an extended cache block, and a cache miss occurs, the missed address is read from the system memory 120 and seven prefetch requests for the other cache lines in the extended cache block are generated. In this manner, size of the extended cache blocks is adjustable at run time on a per partition basis.

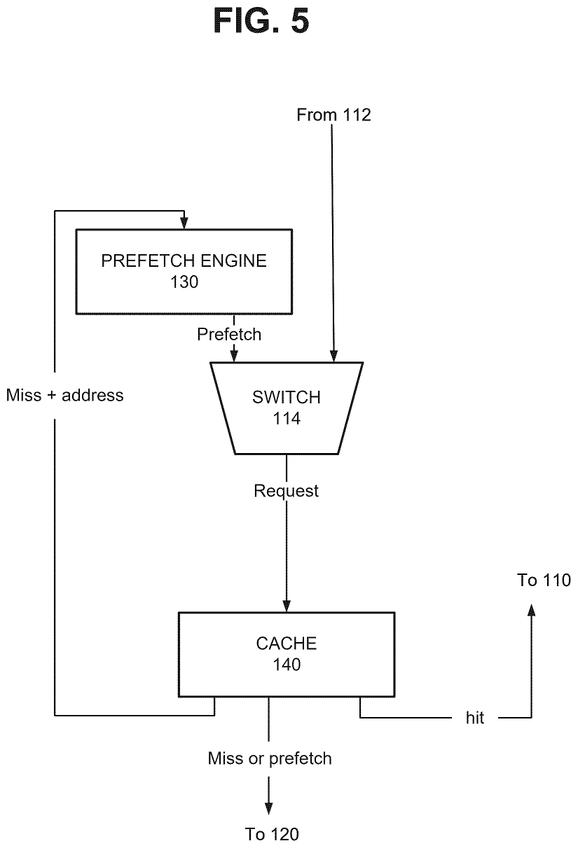

Reference is now made to FIG. 5, which further illustrates the cache 140 and the prefetch engine 130. The prefetch engine 130 may include an automatic prefetcher. The automatic prefetcher may be a state machine that is configured to take a data stream into account as requests suffer from cache misses by issuing prefetch requests. The switch 114 receives prefetch requests from the prefetch engine 130 and read requests from the requesters 110, and arbitrates between the prefetch requests and the read requests. Priority may be given to the requester 110 or the prefetch engine 130, or bandwidth may be divided (e.g., 50%) between the requesters 110 and the automatic prefetcher 510. For example, the bandwidth may be divided equally between the requesters 110 and the prefetch engine 130.

In the example of FIG. 5, the cache 140 is configured to receive and process requests from the switch 114. If the request is a read request, and a cache hit occurs, data from the matched cache line is sent from the cache 140 to the requester 110.

If a cache miss occurs, the cache 140 (via its controller) sends a read request to the system memory 120, and it sends a miss instruction and an address to the prefetch engine 130. The prefetch engine 130 generates prefetch requests for all other cache lines in the extended cache block.

The prefetching on a per partition basis reduces the need for a sophisticated prefetch algorithm. It enables the prefetch engine 130 to utilize a generic prefetching algorithm that does not depend on the application and mimic the behavior or a larger cache line. The number of prefetch requests is tailored to partition characteristics.

The method above is described in connection with read requests. However, the method may also be adapted to write requests and requests for atomic operations (e.g., add, clear, exclusive-or, increment, set). If a cache miss occurs, the missed cache line is read, and prefetch requests are generated for the other cache lines in the same extended cache block as the missed cache line.

An electronic system herein is not limited to any particular type. One example is a system on chip (SoC) including a network-on-chip (NoC).

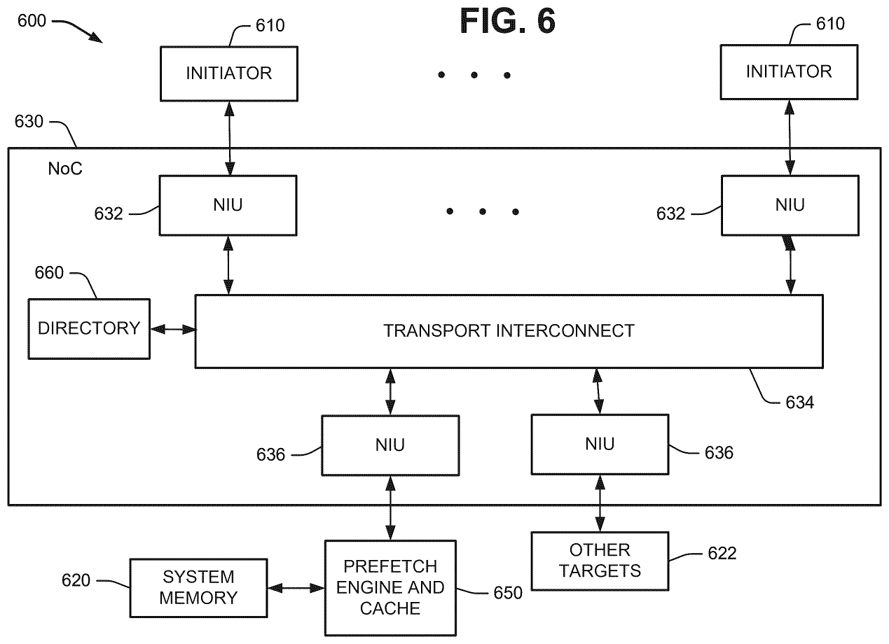

Reference is now made to FIG. 6, which illustrates an SoC 600. The SoC 600 includes a plurality of initiators 610. Examples of the initiators 610 include, but are not limited to, CPUs, GPUs, and accelerators. The CPUs and GPUs typically have cores and caches. The accelerators may or may not have caches.

The SoC 600 further include system memory 620 and other targets 622. The other targets 622, such as peripheral devices, don't use extended cache blocks. The system memory 620 and the other targets 622 will be referred to collectively as “the targets 620, 622.”

The SoC 600 further includes a NoC 630. The NoC 630 sends request transactions from an initiator 610 to one or more of the targets 620, 622 using industry-standard protocols. A request transaction includes an address of one of the targets 620, 622. The NoC 630 decodes the address and transports the request transaction. The target that receives the request transaction then handles the request transaction and sends a response transaction, which is transported back to the initiator 610 via the NoC 630.

The NoC 630 includes a plurality of network interface units (NIUs) 632 and a transport interconnect 634. Each initiator 610 is coupled to the transport interconnect 634 via a corresponding NIU 632. Each target 620 and 622 is coupled to the transport interconnect 634 via a corresponding NIU 636.

Each NIU 632, 636 is configured to convert the protocol used by its corresponding core into a transport protocol used inside the NoC 630. The transport protocol is typically based on the transmission of packets.

The transport interconnect 634 includes switches, adapters, and buffers. Switches may be used to route flows of traffic between source and destinations. Adapters may be used to deal with various conversions between data width, clock and power domains. Buffers may be used to insert pipelining elements to span long distances, or to store packets to deal with rate adaptation between fast senders and slow receivers or vice-versa.

The SoC 600 further includes a prefetch engine and cache that implement the method of FIG. 4. In the example of FIG. 6, the prefetch engine and the cache are part of a module 650 that is located between the NoC 630 and the system memory 620. As but one example, the system memory 620 includes DRAM, and the cache is a “Last Level Cache” located between the NoC 630 and the DRAM. This location enables the prefetch engine to work with different types of initiators 610. It also improves overall latency and power. In general, a cache decreases power consumption by decreasing the number of accesses to system memory. A prefetch engine herein further reduces power consumption indirectly by reducing compute times of prefetch requests.

In the example of FIG. 6, the NoC 630 is cache-coherent. The NoC 630 includes a directory 660 for ensuring cache coherence across the SoC 600 by maintaining consistency of shared data stored in local caches of the initiators 610, data stored in the system memory 620, and data stored in other shared memory. When multiple initiators 610 are accessing and modifying the same memory locations, a NoC 630 that is cache-coherent ensures that any changes made by one initiator 610 are immediately visible to all other initiators 610, thereby preventing data inconsistencies. Advantageously, average data access latency is reduced, yet coherency management is still performed on the smallest cache line size (instead of the entire extended cache block), reducing the amount of data being invalidated.

The prefetch engine and cache are not limited to the location shown in FIG. 6. As a first example, the prefetch engine and cache may be located between the NoC 630 and one or more initiators 610. As a second example, the prefetch engine and the cache may be located inside the NoC 630. As a third example, there may be a prefetch engine and multiple dedicated caches in the SoC 600. The dedicated caches have better latency.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Various examples are methods that use the behavior of either or a combination of machines. Method examples are complete wherever in the world most constituent steps occur. For example, IP elements or units include: processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-filed protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

1. (canceled)

2. The system of claim 5, wherein each partition includes at least one requester configured to generate memory access requests.

3. The system of claim 5, wherein the plurality of partitions are mapped to any of address ranges, a plurality of requesters, and specific information sent by at least one requester of the plurality of requesters.

4. The system of claim 5, wherein the extended cache block size is dependent upon partition traffic patterns and/or partition policies.

5. An electronic system comprising:
a plurality of partitions;
system memory; and
a hardware prefetch engine for performing prefetches on a plurality of cache lines in an extended cache block, wherein the extended cache block includes the plurality of cache lines and at least one missed cache line at a missed address within the extended cache block,
wherein extended cache block size is partition-dependent,
wherein the missed cache line at the missed address is read from the system memory and a number X of prefetch requests are generated for all other cache lines in the extended cache block,
where
$$X = \frac{Block\_size ( partition )}{CL\_size - 1} - 1 ,$$
where Block_size(partition) is the extended cache block size as a function of one of the partitions, and
where CL_size is size of the cache lines in the extended cache block.

6. The system of claim 5, wherein the extended cache block is aligned on its size.

7. The system of claim 5, wherein the prefetch engine is configured to:
use a first field of a memory access request to identify the extended cache block associated with the missed cache line;
use a second field of the memory access request to identify the cache lines in the extended cache block other than the missed cache line; and
generate prefetch requests for all of the cache lines in the extended cache block other than the missed cache line.

8. The system of claim 5, further comprising “Last Level” cache for storing the cache lines.

9. The system of claim 5, wherein the system further comprises cache and a network-on-chip (NoC); wherein the plurality of partitions and the system memory communicate via the NoC; and wherein the prefetch engine and the cache are between the system memory and the NoC.

10. The system of claim 9, wherein the NoC is cache coherent.

11. (canceled)

12. A module for an electronic system including a plurality of partitions and system memory, the module comprising:
cache; and
a prefetch engine configured to respond to a cache miss in an extended cache block, which includes a plurality of cache lines and at least one missed cache line, by generating a number of prefetch requests for the plurality of cache lines in the extended cache block,
wherein the number of prefetch requests is determined at runtime on a per-partition basis,
wherein X denotes the number of prefetch requests, and
$$X = \frac{Block\_size ( partition )}{CL\_size - 1} - 1 ,$$
where Block_size(partition) is size of the extended cache block as a function of a partition, and
where CL_size is the size of a cache line in the extended cache block.

13. The module of claim 12, wherein the extended cache block is an Block_size(partition) bytes memory block Block_size(partition)-aligned.

14. The module of claim 12, wherein the prefetch engine is configured to:
use a first field of a memory access request to identify an extended cache block associated with a missed cache line;
use a second field of the memory access request to identify the cache lines in the extended cache block other than the missed cache line; and
generate prefetch requests for all of the cache lines in the extended cache block other than the missed cache line.

15. The module of claim 12, wherein the cache is a dedicated cache.

16. (canceled)

17. A method implemented by an electronic system including a cache and shared memory, the method comprising:
using a memory access request to search the cache for a cache line; and
when a cache miss occurs:
copying a missed cache line from the shared memory into the cache;
using a first field of the memory access request to identify an extended cache block that includes a plurality of cached lines and the missed cache line;
using a second field of the memory access request to identify the plurality of cache lines in the extended cache block; and
generating prefetch requests for the plurality of cache lines in the extended cache block,
wherein X represents a number of the prefetch requests, and
$$X = \frac{Block\_size ( partition )}{CL\_size - 1} - 1 ,$$
where Block_size(partition) is size of the extended cache block as a function of a partition, and
where CL_size is size of a cache line in the extended cache block.

18. The method of claim 17, wherein the extended cache block is aligned on its size.
